(19) United States
(12) Patent Application Publication
(10) Pub. No.: US 2010/0108181 A1
(43) Pub. Date: May 6, 2010

(54) METHOD OF FILLING BEVERAGE BOTTLES WITH A LIQUID BEVERAGE AND CAPPING FILLED BEVERAGE BOTTLES WITH CROWN CAPS IN A BEVERAGE BOTTLING PLANT, A METHOD OF HANDLING CONTAINERS IN A CONTAINER HANDLING PLANT, AND ARRANGEMENTS THEREFOR

(76) Inventors: Hans Westner, Mandel (DE); Thomas Stienen, Unna (DE)

Correspondence Address: NILS H. LJUNGMAN & ASSOCIATES, P. O. BOX 130, GREENSBURG, PA, 15601-0130, US

(21) Appl. No.: 12/608,693

(22) Filed: Oct. 29, 2009

Related U.S. Application Data
(63) Continuation-in-part of application No. PCT/EP2008/003248, filed on Apr. 23, 2008.

(30) Foreign Application Priority Data
Apr. 30, 2007 (DE) 10 2007 020 625.0

(51) Int. Cl. B65B 31/04; B01D 53/22; B01D 50/00; B65B 7/28

(52) U.S. Cl. 141/4; 55/385.1; 96/4; 141/66; 53/485

(57) ABSTRACT

A method for the processing in one possible embodiment for the packaging of products using an oxygen-free process gas. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2008/003248, filed on Apr. 23, 2008, which claims priority from Federal Republic of Germany Patent Application No. 10 2007 020 625.0, filed on Apr. 20, 2007. International Patent Application No. PCT/EP2008/003248 was pending as of the filing date of this application. The United States was an elected state in International Patent Application No. PCT/EP2008/003248.

### BACKGROUND

1. Technical Field

The present application relates to a method for the processing, in one possible embodiment for the packaging, of products in packaging using an oxygen-free or essentially oxygen-free process gas in a plant for the performance of the method, as well as to the use of a gas filter, in one possible embodiment a membrane filter, in a plant for the processing, in one possible embodiment the packaging of oxygen-sensitive products.

2. Background Information

Background information is for informational purposes only and does not necessarily admit that subsequently mentioned information and publications are prior art.

One problem that is encountered in the packaging of many products as well as many beverages, the shelf life and/or quality and/or taste of such products can be seriously and adversely affected by air or by the oxygen (O, O₂, O₃) in the air. A contamination with oxygen can occur, for example, during packaging or during the filling of the packaging with the product in question and/or after the packaging and before and/or during the closing or capping of the packaging that is being used.

To resolve this problem, some processing of such oxygen-sensitive products is performed using a process gas, which is generally formed by CO₂, whereby this process gas is used, for example, for the production of a protective or cover gas atmosphere in which the processing is performed, such as, for example, the filling of the individual packages with the product and the closing of the packages. Some packaging is also flushed prior to filling with the CO₂ gas that is used as the process gas. The purpose of this flushing is to remove all or almost all of the ambient air which is inside the empty packaging, and thus to remove all or almost all of this oxygen from the packaging and replace it with a process gas that comprises pure oxygen.

One disadvantage of these methods described above is that the inert gas that is used as a process gas is a significant cost factor. One of the results is that the inert gas can be used in some plants in a few, highly-critical, targeted areas.

### OBJECT OR OBJECTS

An object of the present application is to eliminate, restrict, and/or minimize these disadvantages. The present application teaches that this object can be accomplished by a method for the processing, in one possible embodiment for the packaging, of products in packaging using an oxygen-free or essentially oxygen-free process gas in a plant. The process gas is obtained in at least one gas filter of the plant by fractionation of atmospheric air. Another object of the present application may be a plant for the processing, in one possible embodiment for the packaging of products in packaging using an oxygen-free or essentially oxygen-free process gas in a plant. The plant has at least one gas filter for the production of the process gas by fractionation of atmospheric air. The use of a gas fractionator or gas filter, in one possible embodiment of a membrane filter, is the object of a gas filter, in one possible embodiment a membrane filter, which may be used in plants for the processing and/or for the packaging of oxygen-sensitive products for the production of an oxygen-free or essentially oxygen-free process gas.

### SUMMARY

The term “oxygen-sensitive product” as used in the context of this application includes a wide variety of products having a wide variety of consistencies, which are adversely affected by the inclusion or of contamination with oxygen in terms of their shelf life and/or their quality and/or their taste, and/or in terms of their utility, applicability and/or effect.

The term “packaging” as used in the context of the present application includes but is not limited to bottles, tubes, cans, jars, buckets, pails, tins or similar containers, as well as packaging produced from flat material, e.g. laminated flat material, by folding, such as soft packages, bags, etc.

The term “oxygen-free or essentially oxygen-free process gas” as used in the context of the present application is a gas that comprises at least one component that is obtained by the fractionation of ambient or atmospheric air, which comprises no oxygen (O₂ or O or O₃) and/or comprises a percentage of oxygen so low as to be negligible, which does not lead to a significant and/or relevant adverse effect or damage to the respective product. The oxygen-free or essentially oxygen-free process gas then comprises primarily nitrogen or potentially additional components such as small quantities of argon, carbon dioxide and water vapor.

“Fractionation of ambient or atmospheric air” as used in the context of the present application means the separation of the ambient or atmospheric air into its gas and vapor components by the use of at least one gas filter, in one possible embodiment by the use of at least one membrane filter.

“Ambient or atmospheric air” as used in the context of the present application means, in addition to the obvious ambient or atmospheric air, an oxygen-free or essentially oxygen-free process gas which is used multiple times in a circulation method and which is freed of any oxygen contamination that may occur repeatedly before every re-use.

Developments, embodiments and potential application of the present application are described in greater detail below on the basis of possible embodiments and with reference to the accompanying figures. The features of the present application described in the text and/or illustrated in the drawings, individually or in any possible combinations, may be an object of the present application.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application is explained in greater detail below with reference to the possible embodiments illustrated in the accompanying figures, in which:

FIG. 1 is a schematic block or function diagram of a gas filter plant for use on machines or plants for the treatment of bottles or similar containers;

FIG. 2 is a similar illustration showing a cross section through a container handling machine in the form of a closer or capper;

FIG. 3 is an illustration similar to FIG. 1 of a filter system in an additional embodiment of the present application; and

FIG. 4 is a function diagram of a special realization of the gas and/or membrane filter.

### DESCRIPTION OF EMBODIMENT OR EMBODIMENTS

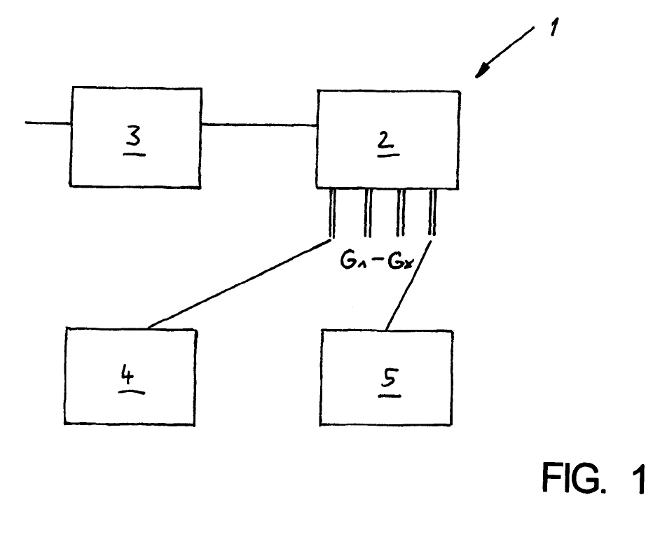

The filter system, which is designated 1 in general in FIG. 1, comprises a mixture of different gas components into the individual gas and/or vapor components, which are each provided individually at the outputs G1-Gx of the filter system 1. The filter system in this application comprises a gas filter 2, in which the fractionation is accomplished by corresponding filer media. The filter media of the gas filter 2 are, for example, realized and positioned in one or more flow channels of the gas filter 2 so that one gas component is obtained at each output. The gas filter 2 is in one possible embodiment realized in the form of a membrane filter in which the individual filter media are formed, for example, by filter membranes, each of which is permeable for the gas component associated with the individual output G1-Gx. Upstream of the gas filter 2 is a sterile filter 3, for example, by means of which the ambient air is fed to the gas filter 2 and in which any particles in the ambient air such as dust, soot, etc. and in one possible embodiment germs and microorganisms of varying types, e.g. fungi, bacteria, viruses etc. are retained, so that clean and sterile ambient air is fed to the gas filter 2 and accordingly clean and sterile gas components are made available at the outputs G1-Gx.

The filter system 1 is designed for use in container handling machines or plants, and is thereby used in one possible embodiment also for plants that are used for the processing, i.e. in one possible embodiments for the bottling or packaging of oxygen-sensitive products.

With the filter system 1, it is now possible to use the components that are made available at the outputs G1-Gx and are harmless for the product being processed, in other words, for example, the components with the exception of the oxygen components (O, O₂, O₃) as process gas for the plant 4 that processes the product in question. The gas components corresponding to the outlets G1-Gx are then combined, for example, and transported to the plant 4. The oxygen components that are available at one and/or more of the outputs are discharged into the atmosphere, for example, or transported to a system 5 in which ozone and or a mixture of air and/or gas that comprises ozone is generated for cleaning and sterilization purposes, for example.

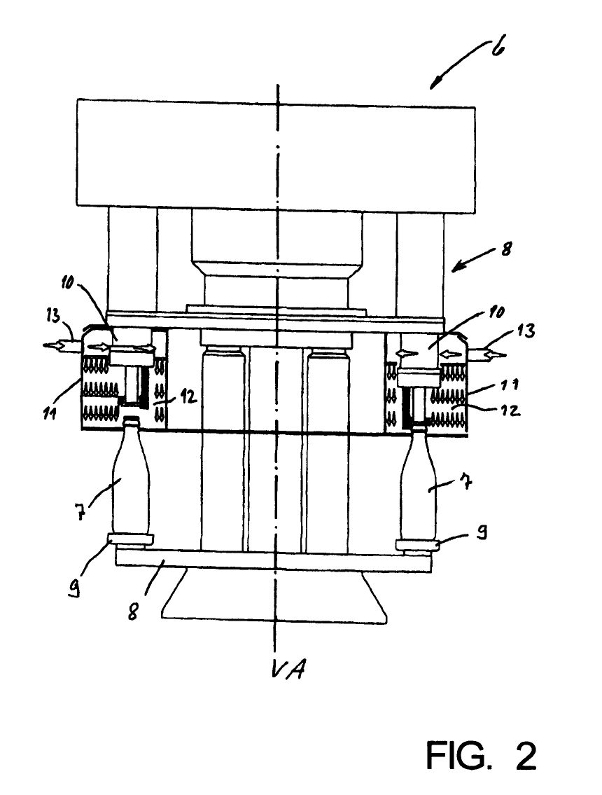

The oxygen-free process gas supplied by the gas filter 2 is used in the plant 4, for example, as a cover gas during the filling of the containers with the oxygen-sensitive product or liquid and during the closing or capping of these containers. One example of this process is illustrated in FIG. 2, which shows a capping machine 6 that employs a rotary construction for the closing or capping of bottles 7 filled with the oxygen-sensitive product. The bottles 7 are fed for the capping to a rotor 8 that is driven in rotation so that it rotates around a vertical machine axis VA so that each bottle is located in the upright position on a bottle plate 9 of the rotor 8, underneath a capping tool 10 which is also provided on the rotor and which is realized for the closing of the bottle with crown corks or other types of caps or closures. The bottles 7 are each held at least by means of a bottle neck that has the bottle or container mouth in a space 12 which is formed by a housing 11 and isolated from the environment, to which the process gas produced from the gas filter 2 is fed via connections 13, and in one possible embodiment so that this process gas flows through the interior 12 from top to bottom and escapes into the atmosphere in the lower portion of the space 12. The entire interior 12 is thereby filled with and flowed through by the oxygen-free process gas. There is also an intensive flow of the process gas around the mouths of the bottles 7.

In a similar fashion, during the filling with the oxygen-sensitive product, i.e. in the capping machine 6 that is upstream in the plant 4, and on the conveyor line between the filling machine and the capping machine 6, the bottles 7 are located in the cover gas atmosphere formed by the process gas of the gas filter 2.

If, during the filling of the bottles 7 before the introduction of the liquid, the interior of the individual bottle is flushed to displace air or the corresponding oxygen component, this flushing can also be done with the oxygen-free process gas supplied from the gas filter 2. For a non-carbonated beverage which is being bottled in the container or bottle 7 pressurized with a gas, the oxygen-free process gas delivered from the gas filter 2 can also be used for the pressurization.

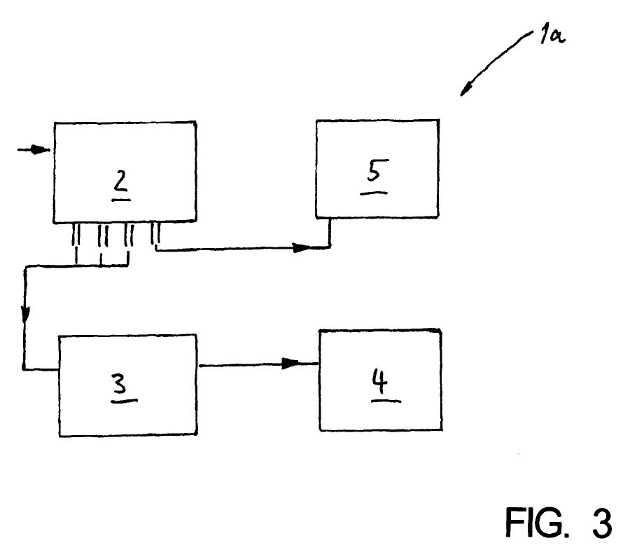

FIG. 3 shows, in an illustration like FIG. 1, a filter system 1a which differs from that filter system essentially in that the sterile filter 3 is downstream of the gas filter 2 for the fractionation of the atmospheric air, and in one possible embodiment so that the components of the fractionated air that are used as process gas in the plant 4 are treated in the sterile filter, which can, among other things, significantly reduce the gas volume to be processed in the sterile filter.

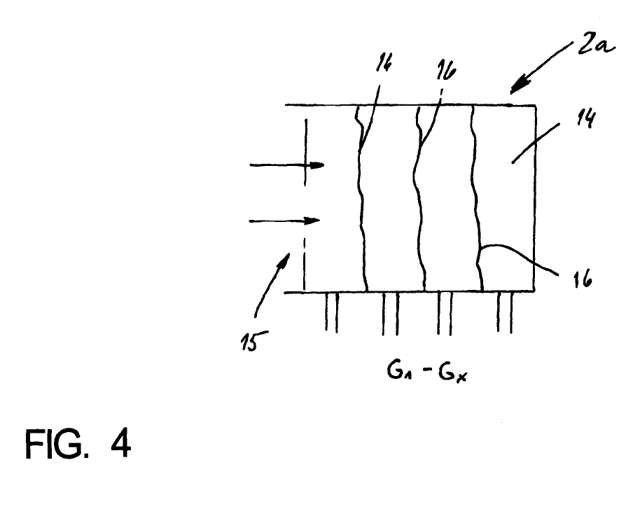

FIG. 4 shows, in a highly simplified functional diagram, the construction of a gas filter 2a. Atmospheric air, e.g. atmospheric air that has previously been cleaned in the sterile filter 3, is fed via an inlet 15 to the interior 14 of this gas filter, and in one possible embodiment by means of a blower, for example. In the interior 14, one after the other in the direction of flow, a plurality of filter membranes 16 are provided. These are selected on the basis of their filtering action so that one gas component is retained on each filter membrane 16, and the remaining gas components pass through. The gas components retained are then made available at the outputs G1-Gx which are associated with the filter membranes.

The present application was described above on the basis of possible embodiments. It goes without saying that numerous modifications and variations can be made without thereby going beyond the teaching of the present application.

In the above description, it was assumed that a separate output G1-Gx is provided for each gas component separated from the atmospheric air by fractionation. Basically, however, it is also possible to realize the individual gas filter so that it has a common output for at least two oxygen-free components. In each case, however, the gas filter must or may be realized so that the product supplied by this filter, e.g. the process gas used in the processing of the oxygen-sensitive product, e.g. during the bottling of this product and/or during the treatment of the packaging used, is oxygen-free.

The teaching of the present application also includes a plant for the bottling of beverages in which at least one capping machine and/or one filling machine and/or the container transport routes between these machines are at least partly protected from atmospheric air and are supplied at least partly with oxygen-free or essentially oxygen-free process gas.

The present application teaches, among other things, that the costs for the supply of an oxygen-free or essentially oxygen-free process gas can be significantly reduced, that said process gas can be used to a much greater degree, which makes possible a further reduction of the oxygen content in the packaged and/or bottled products.

In a method for the processing, in one possible embodiment for the packaging of products in packaging, using an oxygen-free or essentially oxygen-free process gas in a plant, the process gas is obtained in at least one gas filter of this plant by fractionation of atmospheric air.

One feature or aspect of an embodiment is believed at the time of the filing of this patent application to possibly reside broadly in a method for the processing, in one possible embodiment for the packaging, of products in packaging using an oxygen-free or essentially oxygen-free process gas in a plant 4, wherein that the process gas is obtained in at least one gas filter 2, 2a of the plant 4 by fractionation of atmospheric air.

Another feature or aspect of an embodiment is believed at the time of the filing of this patent application to possibly reside broadly in the method, wherein the at least one gas filter is a membrane filter 2, 2a.

Yet another feature or aspect of an embodiment is believed at the time of the filing of this patent application to possibly reside broadly in the method, wherein the atmospheric air fed into the gas filter 2, 2a prior to the fractionation is treated in at least one sterile filter 3 for the separation of foreign objects or particles and for the elimination or reduction of germs or microorganisms.

Still another feature or aspect of an embodiment is believed at the time of the filing of this patent application to possibly reside broadly in the method, wherein the at least one component of the fractionated atmospheric air used as process gas is treated in at least one sterile filter 3.

A further feature or aspect of an embodiment is believed at the time of the filing of this patent application to possibly reside broadly in the method, wherein the oxygen component obtained during the fractionation of the atmospheric air is discharged into the environment and/or is fed to a plant 5 for the collection and/or for the preparation and/or processing of these components, for example a plant for the generation of ozone or ozone gas.

Another feature or aspect of an embodiment is believed at the time of the filing of this patent application to possibly reside broadly in the method, wherein the process gas is used for the realization of an inert gas atmosphere 12 in which the packaging 7 are housed at least with a segment that has the respective packaging opening during the packaging or filling and/or after the packaging or filling at least until the capping or closing of the packaging.

Yet another feature or aspect of an embodiment is believed at the time of the filing of this patent application to possibly reside broadly in the method, wherein the process gas is used for the flushing of the packaging 7 prior to the introduction of the product or liquid being packaged.

Still another feature or aspect of an embodiment is believed at the time of the filing of this patent application to possibly reside broadly in the method, wherein the process gas is used for the pressurization of the packaging 7.

A further feature or aspect of an embodiment is believed at the time of the filing of this patent application to possibly reside broadly in a plant for the processing, in one possible embodiment for the packaging of products in packaging using an oxygen-free or essentially oxygen-free process gas in a plant 4, wherein the plant 4 has at least one gas filter 2, 2a for the production of the process gas by fractionation of atmospheric air.

Another feature or aspect of an embodiment is believed at the time of the filing of this patent application to possibly reside broadly in the plant, wherein the at least one gas filter is a membrane filter 2, 2a.

Yet another feature or aspect of an embodiment is believed at the time of the filing of this patent application to possibly reside broadly in the plant, wherein at least one sterile filter 3 is provided upstream of the at least one gas filter 2, 2a for the separation of foreign objects or particles and for the removal of germs or microorganisms.

Still another feature or aspect of an embodiment is believed at the time of the filing of this patent application to possibly reside broadly in the plant, wherein at last one sterile filter 3 is located downstream of at least one output G1-Gx of the gas filter 2a which supplies the at least one component of the fractionated atmospheric air used as process gas.

A further feature or aspect of an embodiment is believed at the time of the filing of this patent application to possibly reside broadly in the plant as recited, wherein the output of the gas filter 2, 2a which supplies the oxygen component of the fractionated atmospheric air is in communication with the atmosphere and/or with a plant 5 for the collection and/or for the preparation and/or treatment of these components, for example with a plant for the production of ozone or ozone gas.

One feature or aspect of an embodiment is believed at the time of the filing of this patent application to possibly reside broadly in the plant, wherein the plant is a plant for the bottling of beverages in which at least one capping machine and/or one filling machine and/or the container transport routes between these machines are at least partly protected from atmospheric air and are pressurized at least partly with oxygen-free or essentially oxygen-free process gas.

Another feature or aspect of an embodiment is believed at the time of the filing of this patent application to possibly reside broadly in a gas filter, in one possible embodiment membrane filter, wherein it is used in plants 4 for the processing and/or for the packaging of oxygen-sensitive products for the production of an oxygen-free or essentially oxygen-free process gas.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, which were cited in the International Search Report dated Dec. 5, 2008, and/or cited elsewhere are hereby incorporated by reference as if set forth in their entirety herein as follows: FR 2,841,232, having the following English translation of the French title “Nitrogen filling spout for wine bottles has nitrogen injector extending transversely of spout and connected to oxygen supply via valve,” published on Dec. 26, 2003; U.S. Pat. No. 4,894,068, having the title “Process for capturing nitrogen from air using gas separation membranes,” published on Jan. 16, 1990; EP 0 520 863, having the following English translation of the German title “Process and apparatus for producing a controlled atmosphere in a partitioned container for preserving fresh vegetable food products,” published on Dec. 30, 1992; FR 2,826,948, having the following English translation of the French title “Product packaging procedure uses gas at different temperature to fill dead volume in recipient and change product temperature or pressure,” published on Jan. 10, 2003; and US 2003/014949, having the title “Device for replacing air within a container headspace,” published on Jan. 23, 2003.

All of the patents, patent applications or patent publications, which were cited in the German Office Action dated Jan. 22, 2008, and/or cited elsewhere are hereby incorporated by reference as if set forth in their entirety herein as follows: WO 92/04276, having the title “NITROGEN ATMOSPHERES,” published on Mar. 19, 1992; WO 2005/030367, having the title “IMPROVED METHOD FOR SEPARATING GASES FROM A GAS MIXTURE AND DEVICE FOR APPLYING SUCH A METHOD,” published on Apr. 7, 2005; DE 10 2004 005 342, having the following English translation of the German title “Beverage bottling plant for filling bottles with a liquid beverage material and an aseptic bottling system for the aseptic bottling of a liquid material,” published on Sep. 1, 2005; and US 2005/0183853, having the title “Device for optimizing the production of gaseous nitrogen using hollow fiber separation membranes,” published on Aug. 25, 2005.

Some examples of gas filters or methods for filtering gas, which may possibly be utilized or adapted for use in at least one possible embodiment of the present application, may possibly be found in the following U.S. Pat. No. 7,128,777, having the title “Methods and systems for selectively separating CO.sub.2 from a multicomponent gaseous stream to produce a high pressure CO.sub.2 product,” published on Oct. 31, 2006; No. 7,576,319, having the title “Systems for differential ion mobility analysis,” published on Aug. 18, 2009; No. 5,724,805, having the title “Power plant with carbon dioxide capture and zero pollutant emissions,” published on Mar. 10, 1998; and No. 7,594,942, having the title “Gas/liquid separator,” published on Sep. 29, 2009.

Some examples of bottling systems, which may be used or adapted for use in at least one possible embodiment of the present application may be found in the following U.S. patents assigned to the Assignee herein, namely: U.S. Pat. No. 4,911,285; No. 4,944,830; No. 4,950,350; No. 4,976,803; No. 4,981,547; No. 5,004,518; No. 5,017,261; No. 5,062,917; No. 5,062,918; No. 5,075,123; No. 5,078,826; No. 5,087,317; No. 5,110,402; No. 5,129,984; No. 5,167,755; No. 5,174,851; No. 5,185,053; No. 5,217,538; No. 5,227,005; No. 5,413,153; No. 5,558,138; No. 5,634,500; No. 5,713,403; No. 6,276,113; No. 6,213,169; No. 6,189,578; No. 6,192,946; No. 6,374,575; No. 6,365,054; No. 6,619,016; No. 6,474,368; No. 6,494,238; No. 6,470,922; and No. 6,463,964.

Some examples of methods and apparatuses for closing bottles and containers and their components that may possibly be utilized or possibly adapted for use in at least one possible embodiment of the present application may possibly be found in the following U.S. Pat. No. 5,398,485 issued to Osifchin on Mar. 21, 1995; No. 5,402,623 issued to Ahlers on Apr. 4, 1995; No. 5,419,094 issued to Vander Bush, Jr. et al. on May 30, 1995; No. 5,425,402 issued to Pringle on Jun. 20, 1995; No. 5,447,246 issued to Finke on Sep. 5, 1995; and No. 5,449,080 issued to Finke on Sep. 12, 1995.

Some examples of filling machines that utilize electronic control devices to control various portions of a filling or bottling process and that may possibly be utilized or possibly adapted for use in at least one possible embodiment of the present application may possibly be found in the following U.S. Pat. No. 4,821,921 issued to Cartwright et al. on Apr. 18, 1989; No. 5,056,511 issued to Ronge on Oct. 15, 1991; No. 5,273,082 issued to Paasche et al. on Dec. 28, 1993; and No. 5,301,488 issued to Ruhl et al. on Apr. 12, 1994.

U.S. patent application Ser. No. 12/520,705, having the Attorney Docket No. NHL-HOL-229-NP, and having the title “METHOD FOR CAPPING OR CLOSING CONTAINERS AND CAPPING OR CLOSING MACHINE,” is incorporated by reference as if set forth in its entirety herein.

The patents, patent applications, and patent publication listed above in the preceding seven paragraphs are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2007 020 625.0, filed on Apr. 30, 2007, having inventors Hans WESTNER and Thomas STIENEN, and DE-OS 10 2007 020 625.0 and DE-PS 10 2007 020 625.0, and International Application No. PCT/EP2008/003248, filed on Apr. 23, 2008, having WIPO Publication No. WO 2008/131892 and Hans WESTNER and Thomas STIENEN, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the corresponding foreign equivalent patent application(s), that is, PCT/EP2008/003248 and German Patent Application 10 2007 020 625.0, is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2008/003248 and DE 10 2007 020 625.0 from which this patent application claims priority which do not have to do with the correction of the translation in this patent application are not to be included in this patent application in the incorporation by reference.

Any statements about admissions of prior art in the original foreign patent applications PCT/EP2008/003248 and DE 10 2007 020 625.0 are not to be included in this patent application in the incorporation by reference, since the laws relating to prior art in non-U.S. Patent Offices and courts may be substantially different from the Patent Laws of the United States.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1, 1a Filter system
2, 2a Gas filter
3 Sterile filter
4 Plant for the treatment of bottles or similar containers
5 Plant for the production of ozone
6 Capping machine
7 Bottle
8 Rotor
9 Bottle carrier
10 Capping tool
11 Housing
12 Space
13 Connection for process gas
14 Interior of the gas filter 2a
15 Inlet
16 Filter membrane
G1-Gx Outlet of the gas filter 2 or 2a

1. A method of filling beverage bottles with a liquid beverage and capping filled beverage bottles with crown caps in a beverage bottling plant, said method comprising the steps of:
feeding beverage bottles into a beverage bottle flushing and filling arrangement, which beverage bottle flushing and filling arrangement is configured to first flush beverage bottles with an inert gas in order to remove any atmospheric air from the beverage bottles, and then fill flushed beverage bottles with a liquid beverage material;
flushing beverage bottles with an inert gas and displacing and removing atmospheric air from the beverage bottles in said beverage bottle flushing and filling arrangement;
filling flushed beverage bottles with a liquid beverage material in said beverage bottle flushing and filling arrangement;
feeding filled beverage bottles, from said beverage bottle flushing and filling arrangement, into a beverage bottle capping machine, which beverage bottle capping machine is configured to cap filled beverage bottles in an enclosed area filled with an inert gas atmosphere;
flowing inert gas through the enclosed area of said beverage bottle capping machine in order to provide an inert gas atmosphere, which inert gas is inert with respect to said liquid beverage material;
feeding crown caps into said beverage bottle capping machine;
placing crown caps onto the mouths of said filled beverage bottles in the enclosed area of said beverage bottle capping machine; and
supplying inert gas on demand to each of said beverage bottle flushing and filling arrangement and said beverage bottle capping machine directly when needed by filtering atmospheric air in said beverage bottling plant, with at least one membrane filter, and separating said inert gas out of said atmospheric air.

2. Means for performing the method according to claim 1 of filling beverage bottles with a liquid beverage and capping filled beverage bottles with crown caps in a beverage bottling plant, said means comprising:
means for feeding beverage bottles into a beverage bottle flushing and filling arrangement, which beverage bottle flushing and filling arrangement is configured to first flush beverage bottles with an inert gas in order to remove any atmospheric air from the beverage bottles, and then fill flushed beverage bottles with a liquid beverage material;
means for flushing beverage bottles with an inert gas and displacing and removing atmospheric air from the beverage bottles in said beverage bottle flushing and filling arrangement;
means for filling flushed beverage bottles with a liquid beverage material in said beverage bottle flushing and filling arrangement;
means for feeding filled beverage bottles, from said beverage bottle flushing and filling arrangement, into a beverage bottle capping machine, which beverage bottle capping machine is configured to cap filled beverage bottles in an enclosed area filled with an inert gas atmosphere;
means for flowing inert gas through the enclosed area of said beverage bottle capping machine in order to provide an inert gas atmosphere, which inert gas is inert with respect to said liquid beverage material;
means for feeding crown caps into said beverage bottle capping machine;
means for placing crown caps onto the mouths of filled beverage bottles in the enclosed area of said beverage bottle capping machine; and
means for supplying inert gas on demand to each of said beverage bottle flushing and filling arrangement and said beverage bottle capping machine directly when needed by filtering atmospheric air in said beverage bottling plant, with at least one membrane filter, and separating inert gas out of atmospheric air.

3. A gas filter arrangement for performing the method according to claim 1 of filling beverage bottles with a liquid beverage and capping filled beverage bottles with crown caps in a beverage bottling plant, said gas filter arrangement comprising:
a first feeding arrangement being configured to feed beverage bottles into a beverage bottle flushing and filling arrangement, which beverage bottle flushing and filling arrangement is configured to first flush beverage bottles with an inert gas in order to remove any atmospheric air from the beverage bottles, and then fill flushed beverage bottles with a liquid beverage material;
a flushing arrangement being configured to flush beverage bottles with an inert gas and displacing and removing atmospheric air from the beverage bottles in said beverage bottle flushing and filling arrangement;
a filling arrangement being configured to fill flushed beverage bottles with a liquid beverage material in said beverage bottle flushing and filling arrangement;
a second feeding arrangement being configured to feed filled beverage bottles, from said beverage bottle flushing and filling arrangement, into a beverage bottle capping machine, which beverage bottle capping machine is configured to cap filled beverage bottles in an enclosed area filled with an inert gas atmosphere;
a flowing arrangement being configured to flow inert gas through the enclosed area of said beverage bottle capping machine in order to provide an inert gas atmosphere, which inert gas is inert with respect to said liquid beverage material;
a third feeding arrangement being configured to feed crown caps into said beverage bottle capping machine;
a placing arrangement being configured to place crown caps onto the mouths of filled beverage bottles in the enclosed area of said beverage bottle capping machine; and
a supplying arrangement being configured to supply inert gas on demand to each of said beverage bottle flushing and filling arrangement and said beverage bottle capping machine directly when needed by filtering atmospheric air in said beverage bottling plant, with at least one membrane filter, and separating inert gas out of atmospheric air.

4. The method according to claim 1 of filling beverage bottles with a liquid beverage and capping filled beverage bottles with crown caps in a beverage bottling plant, wherein said method further comprises:
treating said atmospheric air in at least one sterile filter before said step of supplying inert gas on demand to each of said beverage bottle flushing and filling arrangement and said beverage bottle capping machine directly when needed by filtering atmospheric air in said beverage bottling plant, with at least one membrane filter, and separating said inert gas out of said atmospheric air; and
treating said inert gas in at least one sterile filter before said step of supplying inert gas on demand to each of said beverage bottle flushing and filling arrangement and said beverage bottle capping machine directly when needed by filtering atmospheric air in said beverage bottling plant, with at least one membrane filter, and separating said inert gas out of said atmospheric air.

5. The method according to claim 4 of filling beverage bottles with a liquid beverage and capping filled beverage bottles with crown caps in a beverage bottling plant, wherein:
the oxygen component obtained during the fractionation of the atmospheric air is discharged into the environment and/or is fed to a plant (5) for the collection and/or for the preparation and/or processing of these components, for example a plant for the generation of ozone or ozone gas;
the process gas is used for the realization of an inert gas atmosphere (12) in which the packaging (7) are contained at least with a segment that has the respective packaging opening during the packaging or filling and/or after the packaging or filling at least until the capping or closing of the packaging;
the process gas is used for the flushing of the packaging (7) prior to the introduction of the product or liquid being packaged; and
the process gas is used for the pressurization of the packaging (7).

6. A method of capping filled beverage bottles with crown caps in a beverage bottling plant, said method comprising the steps of:
feeding beverage bottles filled with a liquid beverage material into a beverage bottle capping machine, which beverage bottle capping machine is configured to cap filled beverage bottles in an enclosed area filled with an inert gas atmosphere;
flowing inert gas through the enclosed area of said beverage bottle capping machine in order to provide an inert gas atmosphere, which inert gas is inert with respect to said liquid beverage material;
feeding crown caps into said beverage bottle capping machine;
placing crown caps onto the mouths of said filled beverage bottles in the enclosed area of said beverage bottle capping machine; and
supplying inert gas on demand to said beverage bottle capping machine by filtering atmospheric air in said beverage bottling plant, with at least one gas filter, and separating said inert gas out of said atmospheric air.

7. Means for performing the method according to claim 6 of capping filled beverage bottles with crown caps in a beverage bottling plant, said means comprising:
means for feeding beverage bottles filled with a liquid beverage material into a beverage bottle capping machine, which beverage bottle capping machine is configured to cap filled beverage bottles in an enclosed area filled with an inert gas atmosphere;
means for flowing inert gas through the enclosed area of said beverage bottle capping machine in order to provide an inert gas atmosphere, which inert gas is inert with respect to the liquid beverage material;
means for feeding crown caps into said beverage bottle capping machine;
means for placing crown caps onto the mouths of filled beverage bottles in the enclosed area of said beverage bottle capping machine; and
means for supplying inert gas on demand to said beverage bottle capping machine by filtering atmospheric air in said beverage bottling plant, with at least one gas filter, and separating inert gas out of the atmospheric air.

8. A gas filter arrangement for performing the method according to claim 6 of capping filled beverage bottles with crown caps in a beverage bottling plant, said gas filter arrangement comprising:
a feeding arrangement being configured to feed beverage bottles filled with a liquid beverage material into a beverage bottle capping machine, which beverage bottle capping machine is configured to cap filled beverage bottles in an enclosed area filled with an inert gas atmosphere;
a flowing arrangement being configured to flow inert gas through the enclosed area of said beverage bottle capping machine in order to provide an inert gas atmosphere, which inert gas is inert with respect to the liquid beverage material;
a feeding arrangement being configured to feed crown caps into said beverage bottle capping machine;
a placing arrangement being configured to place crown caps onto the mouths of filled beverage bottles in the enclosed area of said beverage bottle capping machine; and
a supplying arrangement being configured to supply inert gas on demand to said beverage bottle capping machine by filtering atmospheric air in said beverage bottling plant, with at least one gas filter, and separating inert gas out of the atmospheric air.

9. The method according to claim 6 of capping filled beverage bottles with crown caps in a beverage bottling plant, wherein:
said at least one gas filter comprises at least one membrane filter; and
said method further comprises:
treating said atmospheric air in at least one sterile filter before said step of filtering atmospheric air in said beverage bottling plant, with at least one gas filter, and separating said inert gas out of said atmospheric air; and
treating said inert gas in at least one sterile filter before said step of filtering atmospheric air in said beverage bottling plant, with at least one gas filter, and separating said inert gas out of said atmospheric air.

10. The method according to claim 9 of capping filled beverage bottles with crown caps in a beverage bottling plant, wherein:
the oxygen component obtained during the fractionation of the atmospheric air is discharged into the environment and/or is fed to a plant (5) for the collection and/or for the preparation and/or processing of these components, for example a plant for the generation of ozone or ozone gas;
the process gas is used for the realization of an inert gas atmosphere (12) in which the packaging (7) are contained at least with a segment that has the respective packaging opening during the packaging or filling and/or after the packaging or filling at least until the capping or closing of the packaging;
the process gas is used for the flushing of the packaging (7) prior to the introduction of the product or liquid being packaged; and
the process gas is used for the pressurization of the packaging (7).

11. A method of handling containers in a container handling plant, said method comprising the steps of:
feeding containers into a container handling machine, which container handling machine is configured to handle containers in an inert gas atmosphere;
filtering atmospheric air in said container handling plant, with at least one gas filter, and separating said inert gas out of said atmospheric air; and
supplying inert gas to said container handling machine in order to provide an inert gas atmosphere, which inert gas is inert with respect to the contents of said containers.

12. Means for performing the method according to claim 11 of handling containers in a container handling plant, said means comprising:
means for feeding containers into a container handling machine, which container handling machine is configured to handle containers in an inert gas atmosphere;
means for filtering atmospheric air in said container handling plant, with at least one gas filter, and separating inert gas out of atmospheric air; and
means for supplying inert gas to said container handling machine in order to provide an inert gas atmosphere, which inert gas is inert with respect to the contents of the containers.

13. An air filtering arrangement for performing the method according to claim 11 of handling containers in a container handling plant, said air filtering arrangement comprising:
a feeding arrangement being configured to feed containers into a container handling machine, which container handling machine is configured to handle containers in an inert gas atmosphere;
at least one gas filter being configured to filter atmospheric air in said container handling plant and separating inert gas out of atmospheric air; and
a supplying arrangement being configured to supply inert gas to said container handling machine in order to provide an inert gas atmosphere, which inert gas is inert with respect to the contents of the containers.

14. The method according to claim 11 of handling containers in a container handling plant, wherein said at least one gas filter comprises at least one membrane filter.

15. The method according to claim 14 of handling containers in a container handling plant, wherein said method further comprises treating said atmospheric air in at least one sterile filter before said step of filtering atmospheric air in said container handling plant, with at least one gas filter, and separating said inert gas out of said atmospheric air.

16. The method according to claim 15 of handling containers in a container handling plant, wherein said method further comprises treating said inert gas in at least one sterile filter before said step of filtering atmospheric air in said container handling plant, with at least one gas filter, and separating said inert gas out of said atmospheric air.

17. The method according to claim 16 of handling containers in a container handling plant, wherein the oxygen component obtained during the fractionation of the atmospheric air is discharged into the environment and/or is fed to a plant (5) for the collection and/or for the preparation and/or processing of these components, for example a plant for the generation of ozone or ozone gas.

18. The method according to claim 17 of handling containers in a container handling plant, wherein the process gas is used for the realization of an inert gas atmosphere (12) in which the packaging (7) are contained at least with a segment that has the respective packaging opening during the packaging or filling and/or after the packaging or filling at least until the capping or closing of the packaging.

19. The method according to claim 18 of handling containers in a container handling plant, wherein the process gas is used for the flushing of the packaging (7) prior to the introduction of the product or liquid being packaged.

20. The method according to claim 19 of handling containers in a container handling plant, wherein the process gas is used for the pressurization of the packaging (7).
